(19) United States
(12) Patent Application Publication
(10) Pub. No.: US 2006/0054571 A1
(43) Pub. Date: Mar. 16, 2006

(54) Continuous loop filter media and method of filtering particulate

(76) Inventor: Gerardo Velazquez Lopez, Satillo (MX)

Correspondence Address: WILLIAM J. SCHRAMM, P. O. BOX 4390, TROY, MI, 48099-4390, US

(21) Appl. No.: 10/938,007

(22) Filed: Sep. 10, 2004

(51) Int. Cl. B01D 33/04

(52) U.S. Cl. 210/783; 210/393; 210/400; 210/797

(57) ABSTRACT

Described is a continuous loop filter media and a method of filtering particulate, such as metal, from a liquid media comprising supplying a filter media 12 of a type supported in a flow passage which is used to filter particulate 56 from the liquid; wherein the filter media is comprised of at least two fabrics, a first top fabric 62 comprised of non-woven synthetic fibers 80 and a second bottom fabric 60 comprised of yarn pre-designed into a shaped porous support layer, such as, woven fibers 84, 86, 88, the first and second fabrics lying substantially on top of each other and bound together 62, 64, 66, 74 to form a continuous loop filter media; passing the continuous loop filter media into a first stage comprised of liquid and waste particulate and filtering at least a portion of the particulate therefrom onto the continuous loop filter media; passing the continuous loop filter media with the filtered particulate thereon to a removal stage 52 wherein at least a portion of the filtered particulate is separated from the continuous loop filter media; and passing the continuous loop filter media back to the first stage.

### FIELD OF THE INVENTION

The invention pertains to the utilization of improved continuous loop filter media in a process for filtering particulates from an aqueous liquid, including for example metal particulate.

### BACKGROUND OF THE INVENTION

In the metal working field coolants are applied to a substrate during a metal working process such as grinding or machining. The coolant as it leaves the substrate will therefore contain metal fines from the metal working process. In order to re-utilize the coolant, it becomes necessary to filter the coolant to separate the metal fines.

When continuous loop filter media is utilized, the metal fines and other metal particulate must be removed from the continuous loop filter media in order to have satisfactory filtering of the liquid take place. It is therefore desirable to be able to separate the metal fines in a satisfactory and efficient manner in order to utilize the continuous loop filter media for as long a period as possible. Significant down time for the equipment is required, should the continuous loop filter media be changed more repeatedly than necessary. Therefore, the continuous loop filter media must be designed not only to be able to adequately filter the metal particulate but also to facilitate separation of the metal particulate from the continuous loop filter media during the filtering process.

Continuous loop filter media comprised of canvas or cellulose based materials of a single fabric have been used for filtering metal fines in the past. The canvas fabric has had a tendency to retain the metal particulate and has a short life in the filtering process. The single canvas fabric has a tendency to fall apart after a period of time of being exposed to the dirty liquid containing the metal fines.

In the metal working industry, there is a need for having a continuous loop fabric that can withstand the metal fines both during the filtering process and in the removal of the metal fines in the filtering process and to have the filter remain effective and efficient for filtering for an extended period of time.

### SUMMARY OF THE INVENTION

A method of filtering particulate from a liquid media comprising supplying a filter media of a type supported in a flow passage which is used to filter particulate from the liquid; wherein the filter media is comprised of at least two fabrics, a first top fabric comprised of non-woven synthetic fibers and a second bottom fabric comprised of yarn pre-designed into a shaped porous support layer, the first and second fabrics lying substantially on top of each other and bound together to form a continuous loop filter media; passing the continuous loop filter media into a first stage comprised of liquid and waste particulate and filtering at least a portion of the particulate therefrom onto the non-woven fabric of the continuous loop filter media; passing the continuous loop filter media with the filtered particulate thereon to a removal stage wherein at least a portion of the filtered particulate is separated from the continuous loop filter media; and passing the continuous loop filter media, after removal of at least a portion of the filtered particulate is removed, back to the first stage.

Another embodiment of the invention is a continuous loop filter media comprised of a filter media of a type supported in a flow passage which is used to filter metal particulate from the liquid; wherein the filter media is comprised of at least two fabrics, a first top fabric comprised of non-woven synthetic fibers and a second bottom fabric comprised of yarn pre-designed into a shaped porous support layer, the first and second fabrics lying substantially on top of each other and bound together to form a continuous loop filter media wherein the metal particulate is filtered onto the non-woven fabric.

### BRIEF DESCRIPTION OF THE DRAWINGS

FIG. 1 is a schematic diagram of the continuous loop filter media apparatus in the process of the present invention;

FIG. 2 is a bottom fabric of the continuous loop filter media of the present invention;

FIG. 3 is a top non-woven fabric portion of the continuous loop filter media of the present invention;

FIG. 4 is an expanded view of the fibers shown in the fabric of FIG. 3; and

FIG. 5 is an expanded view of the fabric of FIG. 2.

### DETAILED DESCRIPTION OF THE INVENTION

The invention as described herein takes into account the drawings as further included therein. These and other objects, advantages and features of the invention will become apparent to those skilled in the art upon consideration of the following description of the invention.

Definitions: Non-woven fabric means a fabric made from staple lengths or continuous fibers positioned in a random manner and bonded together. Non-woven is meant to include felt, spun bonded, wet laid fabrics and carded fabrics and the like.

By fabric comprised of yarn pre-designed into a shaped porous support layer is meant a fabric that has a pre-designed configuration. By pre-designed configuration means that the fabric is comprised of a yarn that makes up the fabric into a pre-designed shape such as woven fabric, knit fabric, extruded netting, perforated fabric and the like. Each of these fabrics has a pre-designed consistent structure associated with them and is a porous support layer for the non-woven layer. Throughout the specification one type of this fabric is a woven fabric and reference will be made to a woven fabric, even though the other types of pre-designed configurations for the shaped porous support layer fabric may be utilized.

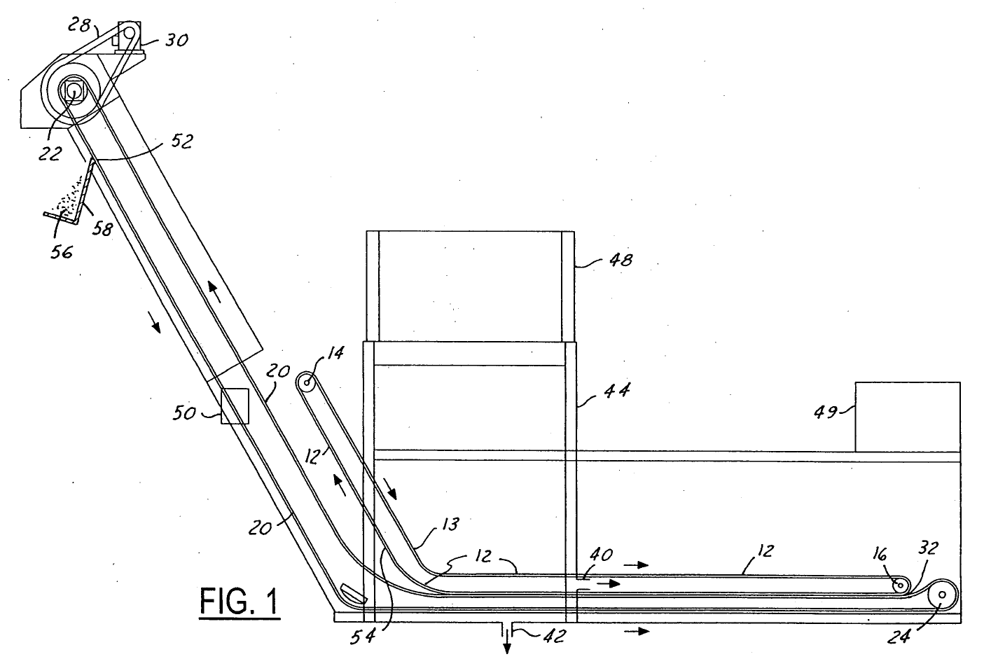

In the present invention, a schematic diagram for a filtering apparatus 10 is shown in FIG. 1. The continuous loop filter media 12 moves from right to left during the filtering process following the arrows shown in FIG. 1 wherein the filter media moves around pulleys 14 and 16. The mechanism for moving pulleys 14 and 16 are not shown.

Continuous chain 20 moves around pulleys 22 and 24 and moves in the direction of the arrows shown in FIG. 1. The pulley 22 is moved by belt drive 28 with a motor on block portion 30 driving the belt 28. The chain 20 engages the continuous loop filter media in the dirty media at about reference point 32. The chain is indexed to move the continuous loop filter media 12 through the holding container 38. An inlet 40 supplies the dirty liquid containing the coolant, oil, grease and other media together with the fines into the container 38. The liquid including the fines is filtered through the continuous loop filter media 12. The filtered liquid exits through outlet conduit 42. The dirty liquid flows through inlet 40, through the filter media 12 where at least a portion of the fines, such as, metal is separated from the liquid, and the liquid passes to exit conduit 42.

In some filtering apparatus, a vacuum may be pulled to facilitate separation of the liquid from the particulate in chamber 38 using a compressor stored in section 48. Connection conduits between chamber 38 and section 48 are not shown. The filter apparatus may have separate chambers such as liquid pumping section 44 or motor section 49 for moving the liquid in the filtering apparatus through conduits (not shown). The chain 20 and continuous loop filter media 12 may be viewed through view glass 50.

The fines 56 may be separated from the chain 20 at reference point 52, by virtue of a liquid and/or air spray mechanism or scrapped from the continuous chain 20. The fines 56 are collected in retention tank 58. Alternatively or conjunctively, the filter media may have the fines removed by air or liquid spraying onto the support fabric portion of the continuous loop filter media thereby removing the fines from the non-woven layer. An air or liquid spraying section may also be utilized at reference point 54 to further assist in the fine removal.

The continuous loop filter media 12 has a bottom side 60 that is preferably woven and a top side 62 that is non-woven. The first and second fabrics are bound together by a seam 63 stitched in place with stitches 64 and 66. Because the filtering apparatus may have a length of 15 to 50 feet, the continuous loop filter media not only must be twice that length but must have additional length for gravity removal of liquid or other medium generally at reference point 13 and for additional filter media to go around the pulleys, the filter media may be upwards of 90 feet in length or more. Accordingly, therefore, the filter media will have attaching mechanisms 70, such as, a zipper shown in FIG. 3. The chain 20 has hooks (not shown) that engage the continuous loop filter media through eyelets 72. The chain hooks the continuous loop filter media and indexes the filter media through the chamber 38 which contains the dirty liquid with the metal particulate. The attaching mechanism, such as 70, can obviously vary depending upon the type of media, depending on its corrosiveness and therefore there can be a variety of attaching mechanisms such as belts, buckles, hooks and the like. The seam 74 along the attaching member 70 likewise will be stitched in place to bind the top and bottom members of the filter media.

It is to be appreciated that it may be efficient to replace the non-woven fabric periodically to improve the filtering process and prevent substantial down time of the filtering equipment.

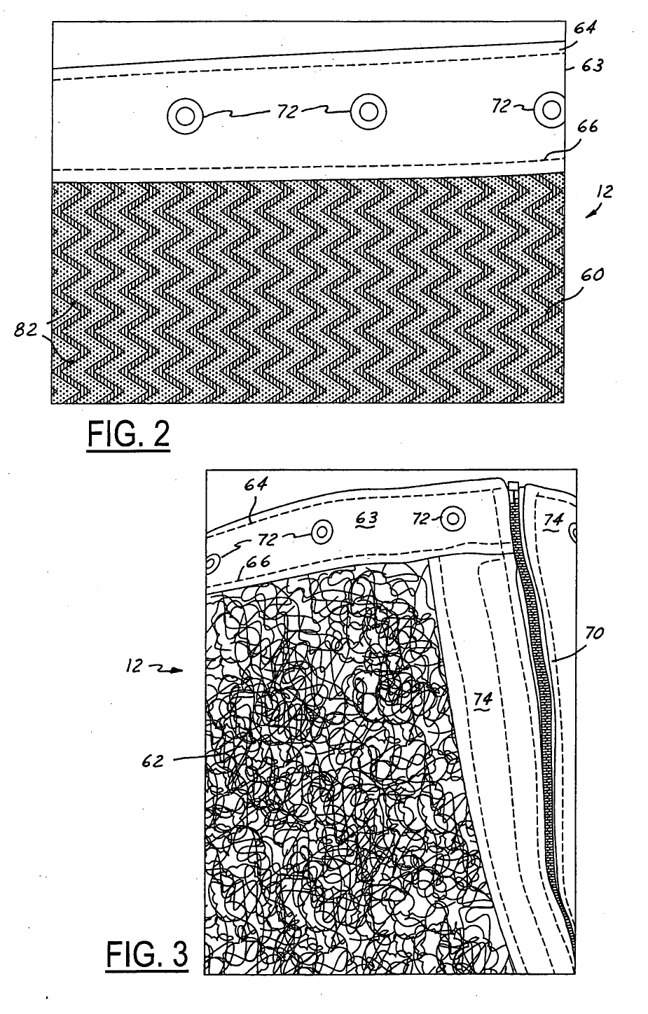

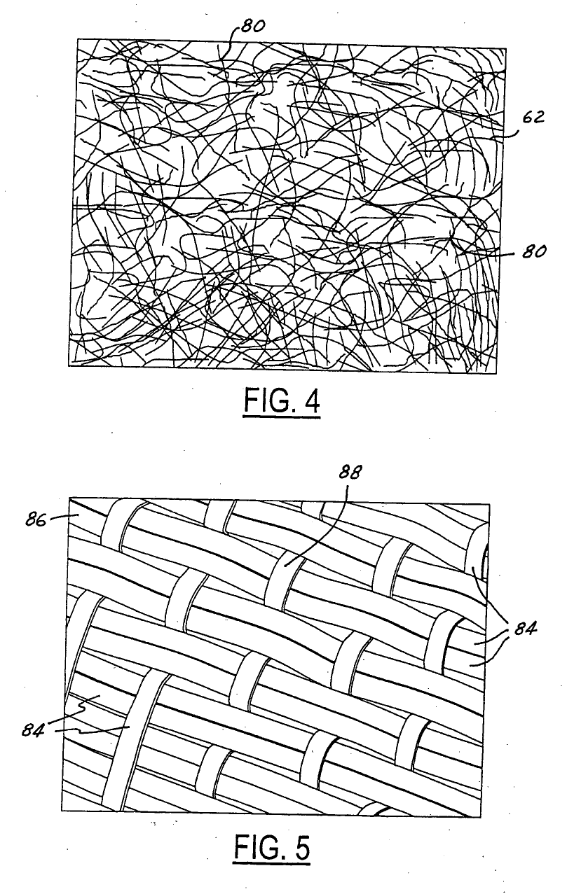

FIG. 4 is an exploded view of the fibers of the non-woven fabric 62 as shown in FIG. 3 where the individual fibers 80 are shown to be varied in length and interact across different locations in a random manner in the non-woven fabric. The woven fabric of FIG. 2 preferably has a waving “V” 82 placed in the fabric during the weaving of the fabric. The waviness assists in the strength of the fabric, in other words, it imparts strength and stretchability to the fabric. A typical fiber weaving arrangement is that shown in FIG. 5 wherein the individual fibers 84 are woven together in a fashion to give the wavy “V” appearance. As can be seen, one portion of the fiber 86 is in a horizontal fashion where another portion of the fiber moves in a vertical fashion 88. FIG. 5 shows that the fiber 88 secures two or more horizontal fibers sufficient to impart the overall wavy “V” 82 as shown in FIG. 2. The fibers 84, 86, 88 are preferably extruded polyethylene which are designed to withstand sunlight and contain an antioxidant such as UV-11. The horizontal fibers 88 may have greater resistance to sunlight than fibers 86. A typical threat count of the woven fabric is 60 threads by 19 threads per inch.

Because an important aspect of a continuous loop filter media is to be able to remove the filtered metal particulate, it is believed that the combination of the woven and non-woven continuous loop filter media facilitates this process. In addition, while applicant does not wish to be bound to any particular theory, it is believed that the woven fabric 60 stretches during movement along the filtering process and when the fabric is stretched, it more easily has removed the metal fines.

Filter media means a type that is supported across a fluid flow passage for collecting particulate out of the fluid and subsequently being moved out of the flow passage after being congested with particulate. The filter media can make up a wide variety of materials, preferably thermoplastic materials such as polyolefins, such as polypropylene, polyethylene, TPO, nylon, polyester, PET (polyethylene-terephthalate), and the like and mixtures thereof. Some filter media that may be utilized are Cerex®, trademark of Cerex Corporation, Pensicola, Fla. for spun bonded nylon 6.6. Other filter media include CoClean®, trademark of Crystal Filtration of Rochester Hills, Mich. which is a mixture of microfibers such as a blend of polypropylene and polyester microfibers. The filters may be reinforced with polypropylene spun bonded for strength. Other filter media includes Kiara®, trademark of Polymer Group for thermally bonded non-woven material made from polyester fabrics coated with polyethylene. Other filter media includes Microclean®, trademark of Crystal Filtration for polypropylene microfibers sandwiched between layers of spun bonded polypropylene. Other filter media may be spun bonded polyester, polypropylene and the like. Other filter media includes Powerloft®, a trademark of Kimberly Clark for fibrous web material or alternatively rayon and the like. Other filter media may be Ultraloft®, a trademark of Polymer Group for spun bonded polypropylene. Other filter media may be Reemay®, a trademark of BBA for spunbond polyester. Other filter media may be Masterflow®, a trademark of BBA for a polyester filter media. Other media may be Holliflow®, a trademark of Filtration Systems Products for a polyester filter media. Other media may be ATM®, a trademark of Flo-Tec for layered and ultrasonically bonded filter media. Other media may be EnviroClean, a trademark of Crystal Filtration for polyester filter media made from recycled beverage bottles. The filter media that is the support layer may also include knit fabric such as Alumites of SI Performance Fabrics of Gainsville, Ga., which is a knit polyethylene, Naltex® a trademark of Dell Star Technologies for an extruded netting manufactured from synthetic resins such as polypropylene, high and low density polyethylene, nylon, polyester, thermoplastic elastomers such as ethylene vinyl acetate, Santoprene® (trademark of Reed Duffer & Foam Products of St. Louis, Mo.), Kraton® (trademark of Kraton Polymers of Houston, Tex.) and polyvinyl chloride. The support layer may likewise be comprised of Delnet®, trademark of Dell Star Technologies for an apertured film, i.e., a film of a synthetic plastic such as a thermoplastic that has holes space through the film in a pre-designed fashion.

While the non-woven materials are generally preferred to be synthetic fibers to decrease cost a portion of the non-woven fibers may be natural products, for example up to 10% or higher of the amount of non-woven fabric.

It is to be appreciated that there are a wide number of metal working operations which require the utilization of filter media and correspondingly the generation of waste filter media. Some type of metal filtering would include that resulting from the metal processes of rolling, washing, grinding, boring, metal drawing, honing and the like. A variety of metals are subjected to metal working such as aluminum, chrome, copper, steel, iron based materials, stainless steel and mixtures thereof and the like.

It is to be appreciated that the polymeric materials that are used in the filter media maybe crystalline or amorphous thermoplastic materials.

While it is preferred that the filter media is comprised of thermoplastic materials, it is to be appreciated that thermoset materials may likewise be utilized.

It is to be appreciated that while applicant does not wish to be bound to any particular theory of invention, in the spraying of the continuous loop filter media to remove the metal particulate, the spray is applied to the woven portion first thereby extending or stretching the woven portion to increase the efficiency in removing the metal particulate.

In the utilization of a continuous loop filter media, several processing issues should be contemplated including: 1) the fine collection itself, 2) the belt washability which is to remove the metal particulate, and 3) the backwashing, namely, if the liquid pressure in the fine removal stage increases, as it moves through the filter media 12, it may be too difficult to remove the fines from the media. It is believed that the continuous loop filter media of the present invention improves the metal particulate collection and removal thereof without any substantial build up in back pressure of the liquid being sprayed onto the filter media for removal of the particulate.

A preferred continuous loop filter media is a polyester material such as polyethylene-terephthalate (PET) material. The non-woven material likewise is preferably a polyethylene material such as PET. It is to be appreciated that a variety of alternatives of the continuous loop filter media may be employed such as having multiple layers of the non-woven, optionally point bonded together.

A preferred non-woven and woven fabrics are commercially available from Freudenberg of Germany and are comprised of PET materials. Alternatively, the fabrics can be obtained from Fibras of Mexico.

While the form of the invention herein disclosed constitutes presently preferred embodiments, many others are possible. It is not intended herein to mention all of the possible equivalent forms or ramifications of the invention. It is understood that the terms used herein are merely descriptive rather than limiting and that the various changes may be made without departing from the spirit or scope of the invention.

We claim:

1. A method of filtering particulate from a liquid media comprising
supplying a filter media of a type supported in a flow passage which is used to filter particulate from the liquid; wherein the filter media is comprised of at least two fabrics, a first top fabric comprised of non-woven synthetic fibers and a second bottom fabric comprised of yarn pre-designed into a shaped porous support layer, the first and second fabrics lying substantially on top of each other and bound together to form a continuous loop filter media;
passing the continuous loop filter media into a first stage comprised of liquid and waste particulate and filtering at least a portion of the particulate therefrom onto the non-woven fabric of the continuous loop filter media;
passing the continuous loop filter media with the filtered particulate thereon to a removal stage wherein at least a portion of the filtered particulate is separated from the continuous loop filter media; and
passing the continuous loop filter media, after removal of at least a portion of the filtered particulate, back to the first stage.

2. The method of claim 1 wherein the bottom portion of the continuous loop filter media is first contacted in the removal stage by an air or liquid, optionally by spraying the air or liquid onto the woven portion.

3. The method of claim 1 wherein the bottom portion of the filter media is comprised of fibers that are polyethylene or polypropylene or mixtures thereof.

4. The method of claim 1 wherein the non-woven portion of the filter media is comprised of fibers that are polyethylene or polypropylene or mixtures thereof.

5. The method of claim 3 wherein the fibers are comprised of polyethylene phthalate.

6. The method of claim 4 wherein the fibers are comprised of polyethylene phthalate.

7. The method of claim 1 wherein the particulate is metal.

8. The method of claim 1 wherein the bottom fabric is a woven fabric.

9. The method of claims 1 wherein the bottom fabric is a knit fabric.

10. The method of claim 1 wherein the bottom fabric is an extruded netting.

11. The method of claim 1 wherein the bottom fabric is an apertured film.

12. A continuous loop filter media comprised of a filter media of a type supported in a flow passage which is used to filter metal particulate from a liquid; wherein the filter media is comprised of at least two fabrics, a first top fabric comprised of non-woven synthetic fibers and a second bottom fabric comprised of yarn pre-designed into a shaped porous support layer, the first and second fabrics lying substantially on top of each other and bound together to form a continuous loop filter media wherein the metal particulate is filtered onto the non-woven fabric.

13. The filter media of claim 12 wherein the bottom portion of the continuous loop filter media is designed to be contacted first by an air or liquid wash in an apparatus using the continuous loop filter media wherein the filter media filters metal particulate and the filter media containing the filtered metal is contacted by the wash, optionally by spraying a wash air or liquid onto the woven side.

14. The filter media of claim 12 wherein the bottom portion is comprised of the fibers that are polyethylene or polypropylene or mixtures thereof.

15. The filter media of claim 12 wherein the non-woven portion of the filter media is comprised of fibers that are polyethylene or polypropylene or mixtures thereof.

16. The filter media of claim 14 wherein the fibers are comprised of polyethylene phthalate.

17. The filter media of claim 15 wherein the fibers are comprised of polyethylene phthalate.

18. The filter media of claim 12 wherein the bottom fabric is a woven fabric.

19. The filter media of claims 12 wherein the bottom fabric is a knit fabric.

20. The filter media of claim 12 wherein the bottom fabric is an extruded netting.

21. The filter media of claim 12 wherein the bottom fabric is an apertured film.
